(19) United States
(12) Patent Application Publication
(10) Pub. No.: US 2008/0246398 A1
(43) Pub. Date: Oct. 9, 2008

(54) Plasma Display Panel and Method of Preparing Bulkheads Thereof

(75) Inventor: Noriyoshi Shida, Saitama (JP)

Correspondence Address: NIXON & VANDERHYE, PC, 901 NORTH GLEBE ROAD, 11TH FLOOR, ARLINGTON, VA, 22203, US

(73) Assignee: Technion Research & Development Foundation Ltd., Haifa (IL)

(21) Appl. No.: 11/795,494

(22) PCT Filed: Jan. 17, 2006
(86) PCT No.: PCT/JP06/00486

§ 371 Date: Sep. 11, 2007

(30) Foreign Application Priority Data
Jan. 18, 2005 (JP) 2005-010462

(51) Int. Cl. H01J 17/49; H01J 9/02

(52) U.S. Cl. 313/582; 445/24

(57) ABSTRACT

A mirror magnetic field forming device is disposed in each discharge unit space (or discharge cell) of a plasma display panel. The mirror magnetic field forming device is formed by providing magnetic members for respective two bulkheads facing each other through the discharge unit space. The two magnetic members form a mirror magnetic field in the discharge unit space. The mirror magnetic field prevents electrons from colliding with the bulkheads and disappearing.

### TECHNICAL FIELD

The present invention relates to a plasma display panel preferably used for a display for television, a display for information notice, or the like, and a method of preparing bulkheads thereof.

### BACKGROUND ART

A plasma display panel has originally spread as a display panel used for business-use information notice. Nowadays, however, the plasma display panel has widely spread as a display panel used for television, and a market for the plasma display panel for television is growing more.

Whether its application is for television or for information notice, one of the important issues for research and development of the plasma display panel is to increase the brightness of the plasma display panel. A patent document 1 described later discloses a technology of disposing a magnet on the rear of a rear substrate of a plasma display panel. According to this technology, a magnetic field in which lines of magnetic force extend parallel to the surface of the rear substrate can be formed in a discharge cell. This allows charged particles to be trapped in the discharge cell, to thereby increase the brightness.

Moreover, reducing a discharge voltage in the plasma display panel is also one of the important issues for research and development of the plasma display panel. If the discharge voltage can be reduced with the proper brightness maintained, energy necessary to operate the plasma display panel can be reduced. This allows a reduction in power consumption of the plasma display panel. A patent document 2 described later discloses a technology of reducing the discharge voltage in a magnetron method. According to this technology, magnets are attached on bulkheads (or ribs) which define the discharge cell, to thereby form a magnetic field in the discharge cell. This allows high-density plasma generated in the discharge cell. Therefore, even if the discharge voltage is reduced, stable plasma can be generated.
Patent document 1: Japanese Patent Application Laying Open NO. Hei 7-85798
Patent document 2: Japanese Patent Application Laying Open NO. Hei 10-188830

### DISCLOSURE OF INVENTION

### Subject to be Solved by the Invention

Gases such as xenon and neon are enclosed in the discharge cell of the plasma display panel. If an electric field is formed in the discharge cell by using discharge electrodes, electrons transfer, which causes the electrons to collide with the gases. As a result, the gasses are ionized and turned into a plasma state. Thus, in order to increase the brightness, it is desirable to increase the chance that the electrons collide with the gases.

However, some of the electrons that transfer do not collide with the gases but collide with the bulkheads. The electrons that collide with the bulkheads disappear without contribution to plasma formation. In short, the presence of the electrons that collide with the bulkheads and disappear reduces efficiency in the plasma formation and reduces the brightness.

In the technology disclosed in the above-mentioned patent document 1, it is difficult to effectively prevent the electrons from colliding with the bulkheads. This is because the formation itself of the magnetic field in which lines of magnetic force extend parallel to the surface of the rear substrate cannot stop the electron transfer toward the bulkheads. As a result, the technology disclosed in the above-mentioned patent document 1 does not allow the brightness to be sufficiently increased because of the presence of the electrons that collide with the bulkheads and disappear.

In the technology disclosed in the above-mentioned patent document 2, it is also difficult to effectively prevent the electrons from colliding with the bulkheads. According to this technology, admittedly, the magnetic field is formed in the discharge cell, and the transfer of the charged particles is controlled. However, it is difficult to effectively stop the electron transfer toward the bulkheads in the magnetic field formed by this technology. As a result, the technology disclosed in the above-mentioned patent document 2 does not allow the brightness to be sufficiently increased because of the presence of the electrons that collide with the bulkheads and disappear. Therefore, it is difficult to sufficiently reduce the discharge voltage with the proper brightness maintained. Thus, it is difficult to sufficiently reduce the power consumption of the plasma display panel.

In order to solve the above-mentioned conventional problems, it is therefore a first object of the present invention to provide a plasma display panel in which the brightness can be increased by reducing the electrons that collide with the bulkheads, and a method of preparing bulkheads thereof.

Moreover, a second object of the present invention is to provide a plasma display panel in which the power consumption can be reduced by reducing the electrons that collide with the bulkheads, and a method of preparing bulkheads thereof.

### Means for Solving the Object

The above object of the present invention can be achieved by a plasma display panel described in claim 1, the plasma display panel provided with: a first substrate; a second substrate facing the first substrate through a space in which a plurality of discharge unit spaces are formed; a first electrode which is provided for each of the plurality of discharge unit spaces and which is disposed on a surface of either the first substrate and the second substrate, the surface facing the space side; a second electrode which is provided for each of the plurality of discharge unit spaces and which is disposed on a surface of either the first substrate and the second substrate, the surface facing the space side; a plurality of bulkheads for defining the plurality of discharge unit spaces by separating the space, the bulkheads being disposed between the first substrate and the second substrate; and a mirror magnetic field forming device for forming a mirror magnetic field in each of the discharge unit spaces, the mirror magnetic field forming device being disposed in each of the plurality of discharge unit spaces, the mirror magnetic field forming device provided with: a first magnetic member disposed on one of the bulkheads facing each other through the discharge unit spaces; and a second magnetic member disposed on the other of the bulkheads facing each other through the discharge unit space and having a magnetic pole opposite to that of the first magnetic member, the first magnetic member and the second magnetic member forming a magnetic field in which lines of magnetic force extend from the one bulkhead to the other bulkhead to penetrate the discharge unit space, the first magnetic member and the second magnetic member forming the mirror magnetic field in the discharge unit space.

The above object of the present invention can be achieved by a method of preparing bulkheads of a plasma display panel described in claim 10, the method of preparing bulkheads of a plasma display panel provided with: a first substrate; a second substrate facing the first substrate through a space in which a plurality of discharge unit spaces are formed; a first electrode which is provided for each of the plurality of discharge unit spaces and which is disposed on a surface of either the first substrate and the second substrate, the surface facing the space side; a second electrode which is provided for each of the plurality of discharge unit spaces and which is disposed on a surface of either the first substrate and the second substrate, the surface facing the space side; a plurality of bulkheads for defining the plurality of discharge unit spaces by separating the space, the bulkheads being disposed between the first substrate and the second substrate; and a mirror magnetic field forming device for forming a mirror magnetic field in each of the discharge unit spaces, the mirror magnetic field forming device being disposed in each of the plurality of discharge unit spaces, the mirror magnetic field forming device provided with: a first magnetic member disposed on one of the bulkheads facing each other through the discharge unit spaces; and a second magnetic member disposed on the other of the bulkheads facing each other through the discharge unit space and having a magnetic pole opposite to that of the first magnetic member, the first magnetic member and the second magnetic member forming a magnetic field in which lines of magnetic force extend from the one bulkhead to the other bulkhead to penetrate the discharge unit space, the first magnetic member and the second magnetic member forming the mirror magnetic field in the discharge unit space, the method provided with processes of forming a bulkhead layer on the first substrate; disposing magnetic materials in a bar shape, extending from one edge side to the other edge side of the bulkhead layer in a direction parallel to the surface of the first substrate; forming a mask for forming grooves or holes which shape the plurality of discharge unit spaces, on the bulkhead layer to cut the magnetic materials along a direction crossing an extending direction of the magnetic materials; removing one portion of the bulkhead layer and one portion of the magnetic materials on the basis of the mask, to thereby form the plurality of bulkheads, the plurality of discharge unit spaces, a plurality of first magnetic member pieces which make the plurality of first magnetic members, and a plurality of second magnetic member pieces which make the plurality of second magnetic members; and applying a magnetic field to the plurality of first magnetic member pieces and the plurality of second magnetic member pieces in order to provide a magnetic force to the plurality of first magnetic member pieces and the plurality of second magnetic member pieces or in order to match magnetic poles of the plurality of first magnetic member pieces and the plurality of second magnetic member pieces, to thereby form the plurality of first magnetic members and the plurality of second magnetic members.

### BRIEF DESCRIPTION OF DRAWINGS

FIG. 1 is a cross sectional view showing an embodiment of the plasma display panel of the present invention.

FIG. 2 is an arrow II-II direction cross sectional view showing the plasma display panel in FIG. 1.

FIG. 3 is a cross sectional view enlargedly showing one discharge unit space of the plasma display panel in FIG. 1 and its surroundings.

FIG. 4 is an arrow IV-IV direction cross sectional view showing the discharge unit space and its surroundings in FIG. 3.

FIG. 5 is an explanatory diagram showing motion of a charged particle in a mirror magnetic field.

FIG. 6 is a cross sectional view showing a modified example which is an embodiment of the plasma display panel of the present invention and in which magnetic members projecting from the bulkheads are provided.

FIG. 7 is a cross sectional view showing a modified example which is an embodiment of the plasma display panel of the present invention and in which the number of the magnetic members is increased.

FIG. 8 is a cross sectional view showing a modified example which is an embodiment of the plasma display panel of the present invention and in which each of the magnetic members is divided into two member pieces.

FIG. 9 is a cross sectional view showing a modified example which is an embodiment of the plasma display panel of the present invention and in which a waffle-shaped bulkhead structure is adopted.

FIG. 10 is a cross sectional view showing a modified example which is an embodiment of the plasma display panel of the present invention and in which a staggered layout bulkhead structure is adopted.

FIG. 11 is a perspective view showing a process in an embodiment of the method of preparing the bulkheads of the plasma display of the present invention.

FIG. 12 is a perspective view showing a process following FIG. 11.

FIG. 13 is a perspective view showing a process following FIG. 12.

FIG. 14 is a perspective view showing a process following FIG. 13.

FIG. 15 is a perspective view showing a process following FIG. 14.

### DESCRIPTION OF REFERENCE CODES

1 plasma display panel
11 rear substrate (first substrate)
12 front substrate (second substrate)
15 electrode (first electrode)
16 electrode (second electrode)
19, 19A, 19B bulkhead
22, 22A, 22B, 31, 32, 33, 34, 35, 36, 37, 42, 51 magnetic member (first magnetic member, second magnetic member)

### BEST MODE FOR CARRYING OUT THE INVENTION

Hereinafter, the best mode for carrying out the present invention will be explained in each embodiment in order on the basis of the drawings.

(Plasma Display Panel)

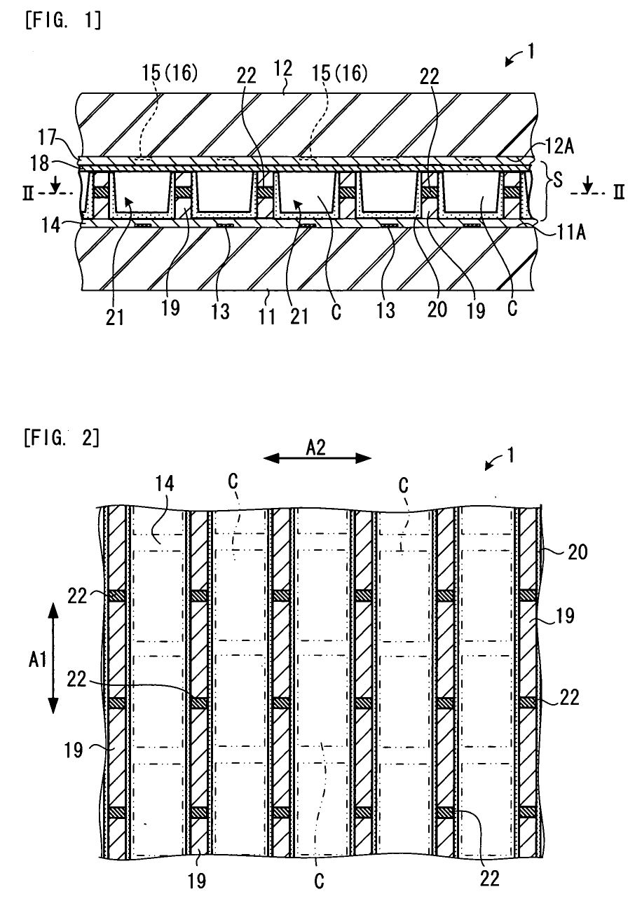

Firstly, with reference to FIG. 1 and FIG. 2, the overall structure of an embodiment of the plasma display panel of the present invention will be explained. FIG. 1 shows a cross section of the embodiment of the plasma display panel of the present invention. FIG. 2 shows a cross section of the plasma display panel in FIG. 1, viewed in an arrow II-II direction.

A plasma display panel 1 is provided with: a rear substrate 11 (first substrate); and a front substrate 12 (second substrate) facing the rear substrate 11 through a space S in which a plurality of discharge unit spaces C are formed. A plurality of electrodes 13 are provided on a surface 11A of the rear substrate 11 facing the space S side. A dielectric layer 14 is provided on the plurality of electrodes 13. On the other hand, a plurality of electrodes 15 (first electrodes) and a plurality of electrodes 16 (second electrodes) are provided on a surface 12A of the front substrate facing the space S side. A dielectric layer 17 is provided on the electrodes 15 and 16. A protective layer 18 is provided on the dielectric layer 17.

On the other hand, a plurality of bulkheads 19 are provided on the dielectric layer 14 located on the rear substrate 11 side, wherein the bulkheads 19 are located between the rear substrate 11 and the front substrate 12 and define the plurality of discharge unit spaces C by separating the space S. Phosphors or fluorescent materials 20 are applied to each of the discharge unit spaces C defined by the bulkheads 19.

Moreover, the plasma display panel 1 has mirror magnetic field forming devices 21 for forming mirror magnetic fields in the discharge unit spaces C. Each of the mirror magnetic field forming devices 21 is provided with two magnetic members 21 and 22 located on two of the bulkheads facing each other through the discharge unit space C.

Next, the elements which constitute the plasma display panel 1 will be further explained.

The rear substrate 11 constitutes a rear panel of the plasma display panel 1. The rear substrate 11 is formed of a glass material, for example. The outer shape of the rear substrate 11 is square, substantially as in the outer shape of the entire plasma display panel 1. The rear substrate 11 is, for example, approximately 2 to 3 mm thick.

The front substrate 12 constitutes a front panel of the plasma display panel 1, namely a display panel. The front substrate 12 is formed of a glass material, for example, and is transparent. The outer shape of the front substrate 12 is square, substantially as in the outer shape of the entire plasma display panel 1. The front substrate 12 is, for example, approximately 2 to 3 mm thick.

The electrodes 13 are mainly to predischarge and form wall charge. Each of the electrodes 13 extends from one edge side to the other edge side of the rear substrate 11 in a direction parallel to the surface 11A of the rear substrate 11 and in a direction parallel to the length direction of the bulkheads 19 (in a column direction, an arrow A1 shown in FIG. 2). The electrodes 13 are thin films formed of a metal material. The electrodes 13 can be formed on the rear substrate 11 by using a technology, such as photolithography.

The dielectric layer 14 is to insulate the electrodes 13 from the surroundings and protect them. The dielectric layer 14 is formed of a dielectric material.

The electrodes 15 and 16 are mainly to discharge in the discharge unit spaces C. Each of the electrodes 15 and 16 is disposed in each of the discharge unit spaces C. The electrodes 15 and 16 are transparent thin films. The electrodes 15 and 16 are formed of indium tin oxide (ITO), for example. The electrodes 15 and 16 can be formed on the front substrate 12 by using a technology, such as photolithography. Incidentally, a transparent signal line (not illustrated) is provided on the surface 12A of the front substrate 12, wherein the signal line extends from one edge side of the other edge side of the front substrate 12 in a direction parallel to the surface 12A and in a direction perpendicular to the length direction of the bulkheads 19 (in a row direction, an arrow A2 shown in FIG. 2). The electrodes 15 are connected to the signal line. Moreover, another signal line (not illustrated) similar to this signal line is provided on the surface 12A of the front substrate 12, and the electrodes 16 are connected to this another signal line.

The dielectric layer 17 is to insulate the electrodes 15 and 16 from the surroundings and is formed of a dielectric material. The protective layer 18 is to protect the electrodes the electrodes 15 and 16 and is formed of magnesium oxide (MgO), for example.

The bulkheads 19 extend from one edge side to the other edge side of the rear substrate 11 in the column direction (the arrow A1 shown in FIG. 2). The dimension of the bulkhead 19 in the direction perpendicular to the surface 11A of the rear substrate 11, namely the height of the bulkhead, is approximately 100 micrometers. The dimension of the bulkhead 19 in the row direction (the arrow A2 shown in FIG. 2), namely the width of the bulkhead, is approximately 60 micrometers. The bulkheads 19 are formed of a glass material, for example. The preparation of the bulkheads 19 can be performed firstly by forming a bulkhead layer made of a glass material on the dielectric layer 14, secondly by masking the bulkhead layer in the shape of the bulkheads 19, and thirdly by removing a part of the glass material using a technology, such as sandblasting. Incidentally, the bulkheads may be formed of a resin material.

The discharge unit spaces C are generally referred to as cells or discharge cells. The discharge is induced mainly by the electrodes 15 and 16 in each of the discharge unit spaces C. The three discharge unit spaces C continued in the row direction constitute one pixel. In the three discharge unit spaces C, the three types of phosphors 20 are applied in order to allow red, green, and blue emission. The gases, such as xenon, neon, and helium, are enclosed in each of the discharge unit spaces C.

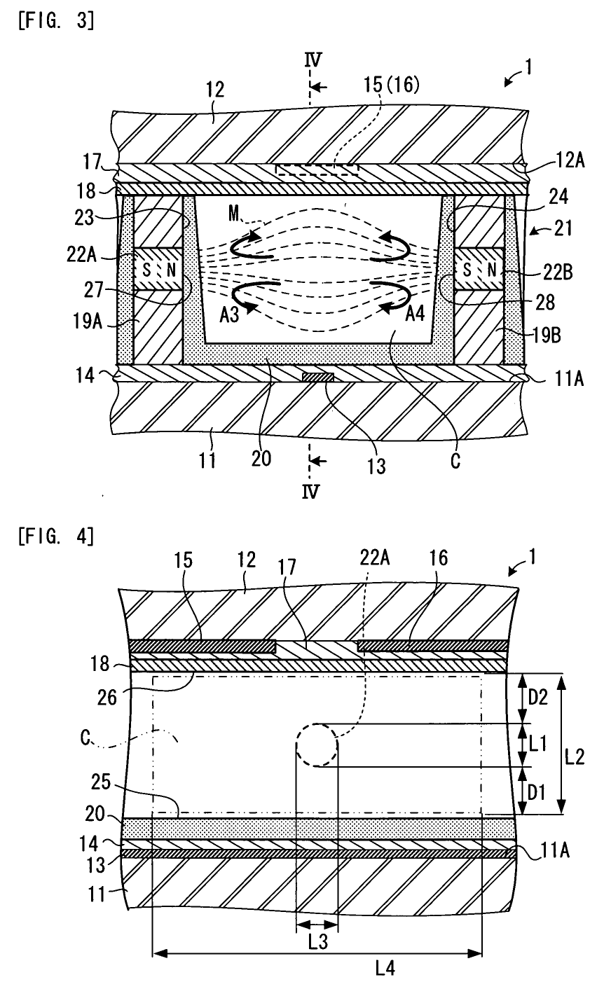

Next, with reference to FIG. 3 and FIG. 4, the structure and the function of the mirror magnetic field forming device 21 will be explained. FIG. 3 enlargedly shows one of the discharge unit spaces C and its surroundings. FIG. 4 shows the discharge unit space C and its surroundings in FIG. 3 viewed in an arrow IV-IV direction. Incidentally, for convenience of explanation, the bulkhead located on the left side of FIG. 3 is set as a “bulkhead 19A”, and the bulkhead located on the right side of FIG: 3 is set as a “bulkhead 19B”. However, the bulkheads 19A and 19B are included in the bulkheads 19 in FIG. 1 and FIG. 2. Moreover, the magnetic member located on the left side of FIG. 3 is set as a “magnetic member 22A”, and the magnetic member located on the right side of FIG. 3 is set as a “magnetic member 22B”. However, the magnetic members 22A and 22B are included in the magnetic members 22 in FIG. 1 and FIG. 2.

The mirror magnetic field forming devices 21 are provided in the respective discharge unit spaces C. Each of the mirror magnetic field forming devices 21 is formed of the magnetic members 22A and 22B.

The material of the magnetic members 22A and 22B is preferably a rare-earth magnet material. Using the rare-earth magnet material to form the magnetic members 22A and 22B of the rare-earth magnet material can give sufficient magnetic force to form a proper mirror magnetic field described later. Moreover, as described later, if the magnetic members 22A and 22B are prepared by processing a bar-like magnetic material in the preparation of the bulkheads of the plasma display, the material of the magnetic members 22A and 22B is preferably a semi-hard magnetic material in view of workability of the magnetic material, and specifically a Fe—Cr—Co plastic forming magnetic material.

The magnetic member 22A is fixed on one bulkhead 19A of the bulkheads facing each other through the discharge unit space C. The magnetic member 22B is fixed on the other bulkhead 19B of the bulkheads facing each other through the discharge unit space C. The magnetic members 22A and 22B face each other, with the discharge unit space C located between them.

The magnetic member 22B has a magnetic pole opposite to that of the magnetic member 22A. For example, if the magnetic member 22A has a north pole, the magnetic member 22B has a south pole. Actually, the magnetic member 22A is located to penetrate the bulkhead 19A from the discharge unit space C to another discharge unit space C located on FIG. 3's left. The edge portion of the magnetic member 22A facing the discharge unit space C side is a north pole, and the edge portion of the magnetic member 22A facing the another discharge unit space C side located on FIG. 3's left is a south pole. In the same manner, the magnetic member 22B is located to penetrate the bulkhead 19B from the discharge unit space C to another discharge unit space C located on FIG. 3's right. The edge portion of the magnetic member 22B facing the discharge unit space C side is a south pole, and the edge portion of the magnetic member 22B facing the another discharge unit space C side located on FIG. 3's right is a north pole. Incidentally, the magnetic members 22A and 22B may have opposite magnetic poles as long as the magnetic poles of the two magnetic members facing each other through one discharge unit space C are opposite to each other.

The magnetic members 22A and 22B form a magnetic field in which lines of magnetic force extend from the bulkhead 19A to the bulkhead 19B to penetrate the discharge unit space C. Moreover, the magnetic members 22A and 22B form a mirror magnetic field M in the discharge unit space C. Therefore, an area closer to the magnetic member 22A or the bulkhead 19A has a stronger magnetic field in the discharge unit space C in which the mirror magnetic field M is formed. Moreover, an area closer to the magnetic member 22B or the bulkhead 19B also has a stronger magnetic field. However, an area away from both the magnetic members 22A and 22B, namely an area located in the center in the discharge unit space C has a weaker magnetic field.

In FIG. 3, dashed lines in the discharge unit space C represent the lines of magnetic force in the magnetic field formed by the magnetic member 22A and the magnetic member 22B. As shown in FIG. 3, the lines of magnetic force in the magnetic field in the discharge unit space C extend from the bulkhead 19A to the bulkhead 19B to penetrate the discharge unit space C. The lines of magnetic forces are at a higher density in the area closer to the bulkheads 19A and 19B and are at a lower density in the area located in the center of the discharge unit space C.

The mirror magnetic field M can control the transfer of charged particles in the discharge unit space as follows. When discharge starts in the discharge unit space C, the charged particles fly, such as electrons emitted from the electrodes 15 and 16, and electrons and ions caused by the collision of electrons with gases. However, most of the charged particles transfer so as to coil round the lines of magnetic force. As a result, in broad perspective, the charged particles transfer from the bulkhead 19A to the bulkhead 19B along the lines of magnetic force. However, when the changed particles approach the bulkhead 19A or 19B, the charged particles turn around and move away from the bulkhead 19A or 19B through the influence of the mirror magnetic field M. In short, the mirror magnetic field M causes the charged particles to be reflected in the vicinity of the bulkheads 19A and 19B. In FIG. 3, arrows A3 and A4 show that the charged particles are reflected in the vicinity of the bulkheads 19A and 19B and the charged particles change the transfer direction because of the mirror magnetic field M.

As described above, in the plasma display panel 1 in the embodiment of the present invention, the magnetic members 22A and 22B are provided for the bulkheads 19A and 19B facing each other through the discharge unit space C, respectively. Moreover, the magnetic members 22A and 22B form the mirror magnetic field M in the discharge unit space C. By virtue of this configuration, the direction of the charged particles transferring to the bulkheads 19A and 19B can be changed in the vicinity of the bulkheads 19A and 19B, to thereby prevent the charged particles from colliding with the bulkheads 19A and 19B. This prevents the electrons emitted from the electrodes 15 and 16 and the electrons ionized from gases from colliding with the bulkheads 19A and 19B and disappearing. In short, this allows the electrons to definitely participate in the plasma formation. Therefore, the plasma formation can be efficiently performed, to thereby increase the brightness. Moreover, since the plasma formation can be efficiently performed, the discharge voltage can be reduced with the proper brightness maintained, and thus the power consumption of the plasma display panel 1 can be reduced.

(Detailed Structure of Mirror Magnetic Field Forming Device)

A further explanation will be given to the specific structure of the mirror magnetic field forming device in the plasma display panel of the present invention.

As shown in FIG. 4, a length L1 of the magnetic member 22A is desirably shorter than a length L2 of the discharge unit space C in a direction perpendicular to the surface 11A of the rear substrate 11. Moreover, a length L3 of the magnetic member 22A is desirably shorter than a length L4 of the discharge unit space C in a direction parallel to the substrate 11A of the rear substrate 11 and in a direction parallel to a surface 23 (refer to FIG. 3) of the bulkhead 19A facing the discharge unit space C side. That is, the shape or size of the magnetic member 22A is desirably smaller than that of the surface 23 of the bulkhead 19A facing the discharge unit space C. Moreover, as shown in FIG. 4, it is more desirable that the shape or size of the magnetic member 22A is relatively point-like compared to that of the surface 23 of the bulkhead 19A.

In the same manner, the length of the magnetic member 22B is desirably shorter than the length of the discharge unit space C in the direction perpendicular to the surface 11A of the rear substrate 11. Moreover, the length of the magnetic member 22B is desirably shorter than the length of the discharge unit space C in the direction parallel to the substrate 11A of the rear substrate 11 and in a direction parallel to a surface 24 (refer to FIG. 3) of the bulkhead 19B facing the discharge unit space C side. That is, the shape or size of the magnetic member 22B is desirably smaller than that of the surface 24 of the bulkhead 19B facing the discharge unit space C. Moreover, it is more desirable that the shape or size of the magnetic member 22B is relatively point-like compared to that of the surface 24 of the bulkhead 19B.

By making the magnetic members 22A and 22B smaller than the surface 23 of the bulkhead 19A and the surface 24 of the bulkhead 19B, respectively, it is possible to increase, in the discharge unit space C, a ratio of the strength of the magnetic field in the vicinity of the bulkheads 19A and 19B with respect to the strength of the magnetic field in the area located in the center of the discharge unit space C. Thus, it is possible to form the mirror magnetic field proper to reflect the charged particles. Moreover, by making the magnetic members 22A and 22B relatively point-like, it is possible to further increase the ratio of the strength of the magnetic field in the vicinity of the bulkheads 19A and 19B with respect to the strength of the magnetic field in the area located in the center of the discharge unit space C. Thus, it is possible to form the mirror magnetic field more proper to reflect the charged particles.

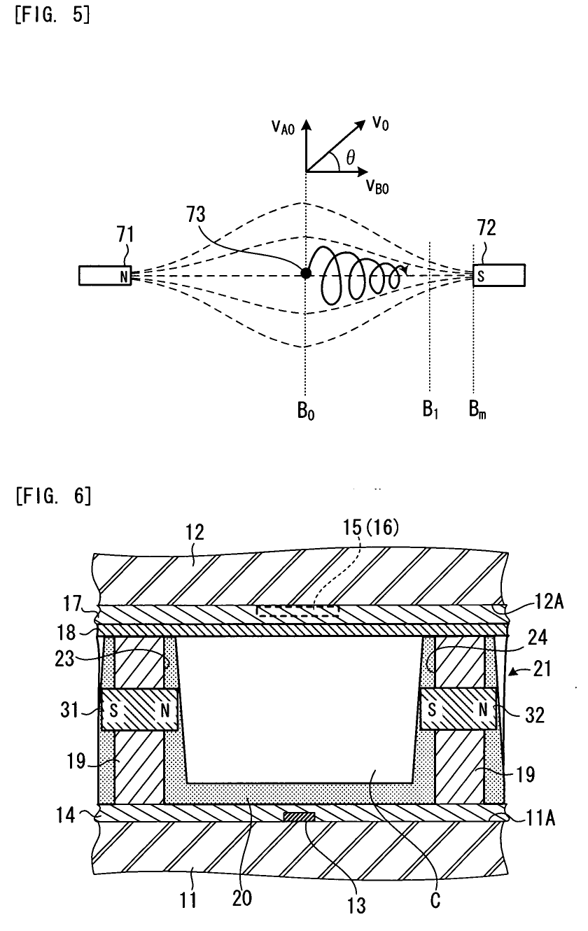

As described above, it is possible to form the mirror magnetic field proper to reflect the charged particles by reducing the shape or size of the surfaces of the magnetic members 22A and 22B facing the discharge unit space C. This technical reason will be explained with reference to FIG. 5.

If two magnets 71 and 72 are kept away from each other but arranged face-to-face, a mirror magnetic field is formed between the magnets 71 and 72, wherein lines of magnetic force are distributed as shown in FIG. 5.

Now, it is assumed that a charged particle 73 passes through a central area of the magnetic field at a velocity V₀. The charged particle 73 has a velocity component V_{A0} perpendicular to the magnetic field and a velocity component V_{B0} in the magnetic-field direction. Moreover, the charged particle 73 moves spirally in the magnetic-field direction at a pitch angle θ in the magnetic field.

As the charged particle 73 approaches the magnet 72, the magnetic field becomes stronger. Along with this, the charged particle 73 reduces the velocity component in the magnetic-field direction. Then, the velocity component in the magnetic-field direction becomes zero at a certain position (or a reflective point) which is close to the magnet 72. At this moment, the charged particle 73 turns around and starts to transfer away from the magnet 72. In other words, the reflection of the charged particle 73 occurs. Here, B₀<B₁<Bₘ is applicable, wherein B₀ is a magnetic flux density in the central area of the magnetic field, Bₘ is a magnetic flux density at a surface position of the magnet 72, and B₁ is a magnetic flux density at the reflective point. Moreover, as described above, V_{B1} is zero if the velocity component perpendicular to the magnetic field of the charged particle 73 at the reflective point is V_{A1} and the velocity component in the magnetic-field direction is V_{B1}.

Now, a magnetic moment μ and a total kinetic energy W are kept constant while the charged particle 73 transfers, so that the following equations (1) and (2) are applicable.

$$\begin{matrix}\text{[Equation 1]} & \\ μ = \frac{\frac{1}{2} {mv}_{A 0}^{2}}{{B}_{0}} = \frac{\frac{1}{2} {mv}_{A 1}^{2}}{{B}_{1}} & ( 1 ) \\ \text{[Equation 2]} & \\ W = \frac{1}{2} {mv}_{A 0}^{2} + \frac{1}{2} {mv}_{B 0}^{2} = \frac{1}{2} {mv}_{A 1}^{2} & ( 2 )\end{matrix}$$

Therefore, the following equation (3) is established from the equations (1) and (2).

$$\begin{matrix}\text{[Equation 3]} & \\ \frac{{B}_{0}}{{B}_{1}} = \frac{{v}_{A 0}^{2}}{{v}_{A 1}^{2}} = \frac{{v}_{A 0}^{2}}{{v}_{0}^{2}} = {sin}^{2} {θ}_{0} & ( 3 )\end{matrix}$$

Incidentally, θ₀ is the pitch angle of the changed particle in the central area. Next, the ratio of the magnetic flux density Bₘ at a position having the maximum mirror magnetic field, namely in the magnetic flux density Bₘ at the surface position of the magnet 72 with respect to the magnetic flux density B₀ at a position having the minimum mirror magnetic field, namely in the magnetic flux density B₀ in the central area of the magnetic field (Bₘ/B₀: mirror ratio) is set as R, and the following equation (4) is determined.

$$\begin{matrix}\text{[Equation 4]} & \\ {sin}^{2} {θ}_{m} = \frac{{B}_{0}}{{B}_{m}} = \frac{1}{{R}_{m}} & ( 4 )\end{matrix}$$

If θ₀>θₘ with respect to the angle θₘ given by the equation (4), then there can be B₁ which satisfies B₀<B₁<Bₘ. Thus, the reflection occurs in the charged particle having this pitch angle. On the other hand, if θ₀<θₘ, the reflection does not occur in the charged particle having this pitch angle.

Therefore, in order that the reflection easily occurs in the charged particle which moves at various pitch angles in the magnetic field, θₘ is desirably reduced. In order to do so, the mirror ratio Rₘ is preferably increased. In order to increase the mirror ratio Rₘ, the areas of the surfaces of the magnets 71 and 72 are desirably reduced, and ideally, the surfaces of the magnets 71 and 72 can be desirably regarded as points.

For the above-mentioned technical reason, in order to increase the chance that the reflection of the charged particle occurs, it is desirable to reduce the shape or size of the surfaces of the magnetic members 22A and 22B facing the discharge unit space C, as shown in FIG. 3 and FIG. 4.

On the other hand, as shown in FIG. 4, it is desirable that a distance D1 between the magnetic member 22A and an inner surface 25 of the discharge unit space C located on the rear substrate side is substantially equal to a distance D2 between the magnetic member 22A and an inner surface 26 of the discharge unit space C located on the front substrate side. Moreover, as shown in FIG. 4, it is desirable that the magnetic member 22A is located in the substantially central part of the surface 23 (refer to FIG. 3) of the bulkhead 19A facing the discharge unit space C.

In the same manner, a distance between the magnetic member 22B and the inner surface 25 is substantially equal to a distance between the magnetic member 22B and the inner surface 26. Moreover, as shown in FIG. 4, it is desirable that the magnetic member 22B is located in the substantially central part of the surface 24 (refer to FIG. 3) of the bulkhead 19B facing the discharge unit space C.

By disposing the magnetic members 22A and 22B in the substantially central part or near the central part of the surfaces 23 and 24 of the bulkheads 19A and 19B facing the discharge unit space C, the magnetic field formed between the magnetic members 22A and 22B is formed to uniformly spread throughout the entire discharge unit space C, as shown in FIG. 3. This allows a large number of charged particles which exist in the discharge unit space C to be controlled to transfer along the lines of magnetic force in the magnetic field. Then, the mirror magnetic field M effectively prevents the large number of charged particles from colliding with the bulkheads 19A and 19B.

On the other hand, as shown in FIG. 3, a surface 27 of the magnetic member 22A facing the discharge unit space C and the surface 23 of the bulkhead 19A facing the discharge unit space C are desirably in the same plane. In the same manner, a surface 28 of the magnetic member 22B facing the discharge unit space C and the surface 24 of the bulkhead 19B facing the discharge unit space C are desirably in the same plane.

By providing the surface 27 of the magnetic member 22A for the surface 23 of the bulkhead 19A and providing the surface 28 of the magnetic member 22B for the surface 24 of the bulkhead 19B, it is possible to increase, in the discharge unit space C, the ratio of the strength of the magnetic field in the vicinity of the bulkheads 19A and 19B with respect to the strength of the magnetic field in the area located in the center of the discharge unit space C. This allows the proper mirror magnetic field M to be formed in the discharge unit space C, which can effectively cause the reflection of charged particles.

Incidentally, as shown in FIG. 6, magnetic members 31 and 32 may be provided instead of the magnetic members 22A and 22B. In other words, the magnetic member 31 may project from the surface 23 of the bulkhead 19A facing the discharge unit space C. In the same manner, the magnetic member 32 may project from the surface 24 of the bulkhead 19B facing the discharge unit space C. Even this configuration can increase, in the discharge unit space C, the ratio of the strength of the magnetic field in the vicinity of the bulkheads 19A and 19B with respect to the strength of the magnetic field in the area located in the center of the discharge unit space C. This allows the proper mirror magnetic field M to be formed in the discharge unit space C. In particular, the phosphor 20 weakens the strength of the magnetic field in the vicinity of the bulkheads 19A and 19B, to thereby prevent the reduction in the ratio of the strength of the magnetic field in the vicinity of the bulkheads 19A and 19B with respect to the strength of the magnetic field in the area located in the center of the discharge unit space C.

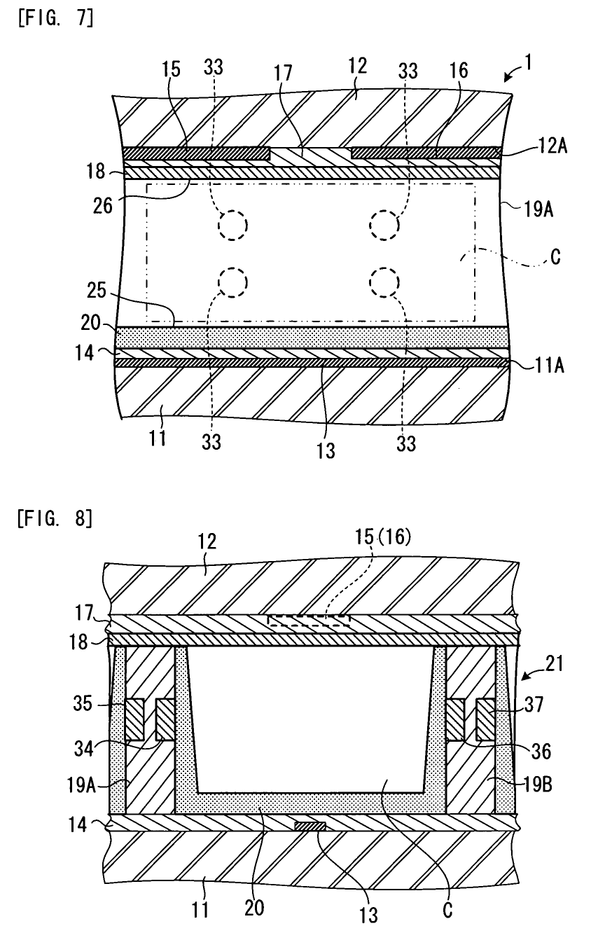

Incidentally, the number of the magnetic member 22A is one in the mirror magnetic field forming device 21 described above; however, the present invention is not limited to this number, and a plurality of magnetic member 22A may be provided. FIG. 7 shows an example in which four magnetic members 33 are formed in each of the two bulkheads 19A and 19B facing each other through one discharge unit space C (illustrated only for the bulkhead 19A). Incidentally, the magnetic members provided for the bulkhead 19A and the magnetic members provided for the bulkhead 19B preferably face each other in position. Thus, the number of the magnetic members provided for the bulkhead 19A is preferably the same as that of the magnetic members provided for the bulkhead 19B. However, the number of the magnetic members provided for the bulkhead 19A may be different from that of the magnetic members provided for the bulkhead 19B if the mirror magnetic field can be properly formed.

Moreover, the mirror magnetic field forming device 21 described above is constructed such that the magnetic members 22A and 22B penetrate the bulkheads 19A and 19B, respectively; however, the present invention is not limited to this configuration. For example, as shown in FIG. 8, the magnetic member provided for the bulkhead 19A may be divided into a member piece 34 which constitutes the mirror magnetic field forming device 21 related to this discharge unit space C and a member piece 35 which constitutes the mirror magnetic field forming device 21 related to another discharge unit space located on the left of the discharge unit space C. The member piece 34 may be located in one portion of the bulkhead 19A located on the discharge unit space C side, and the member piece 35 may be located in one portion of the bulkhead 19A located on another discharge unit space side located on the left of the discharge unit space C. The magnetic member provided for the bulkhead 19B may be divided into member pieces 36 and 37 as well.

(Other Modified Examples)

In the above-mentioned plasma display panel 1, both the electrodes 15 and 16 for discharge are located on the surface 12A of the front substrate 12 (surface-discharge of a reflection type). The present invention, however, is not limited to this type, and both the electrodes 15 and 16 for discharge may be located on the surface 11A of the rear substrate 11 (surface-discharge of a transmission type). Incidentally, in this case, the electrode 13 for predischarge and forming wall charge is provided as a transparent electrode and located on the surface 12A of the front substrate 12. Moreover, one of the two electrodes for discharge may be located on the surface 12A of the front substrate 12, and the other may be located on the surface 11A of the rear substrate 11 (face-type). The arrangement of the magnetic members 22A and 22B is desirably adjusted to form the proper mirror magnetic field, in accordance with the arrangement of the electrodes for discharge.

Moreover, generally, there are a type in which an alternating current is used as the discharge current of the plasma display panel and a type in which a direct current is used. Currently, the plasma display panel of the type in which an alternating current is used is normally used; however, the present invention can be also applied to the plasma display panel of the type a direct current is used.

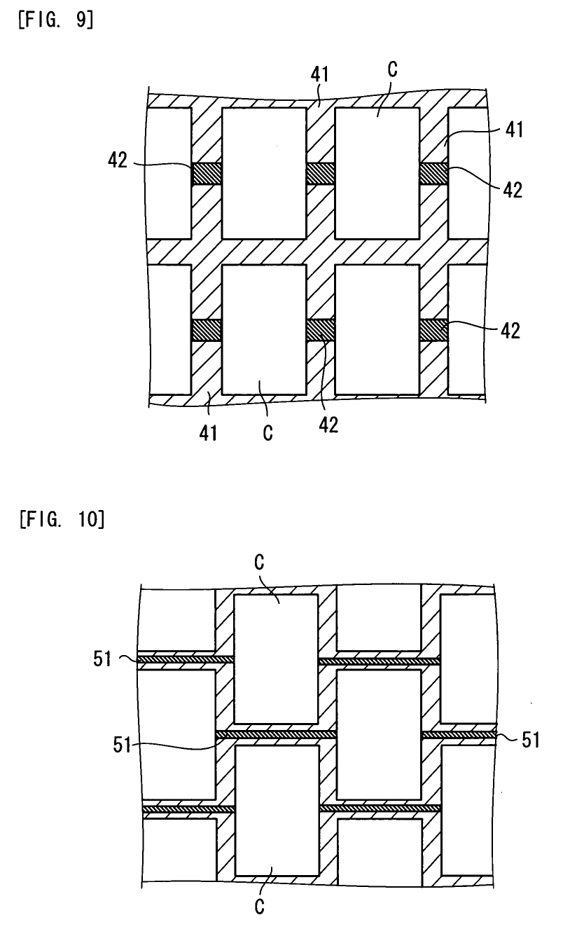

Moreover, as the bulkhead structure of the plasma display panel, there are known a structure in which a plurality of bulkheads are arranged in a stripe shape on the rear substrate 11 (or the dielectric layer 14), as shown in FIG. 2, and a structure in which a plurality of bulkheads 41 are arranged in a waffle or grid shape on the rear substrate 11 (or the dielectric layer 14), as shown in FIG. 9. The present invention can be applied to any bulkhead structure. If the present invention is applied to the structure in which a plurality of bulkheads are arranged in a waffle or grid shape on the rear substrate 11 (or the dielectric layer 14), magnetic members 42 is desirably arranged to face each other through the discharge unit space C, as shown in FIG. 9.

Moreover, the present invention can be also applied to such a case that there are shifts in the positions of the plurality of discharge unit spaces C defined in a certain column and the positions of the plurality of discharge unit spaces C defined in a next column and that the plurality of discharge unit spaces C have a so-called staggered layout. In this case, the shapes of magnetic members 51 may be relatively long bar-like. This facilitates the adjustment of a magnetic field from the magnetic members 51.

(Method of Preparing Bulkheads of Plasma Display Panel)

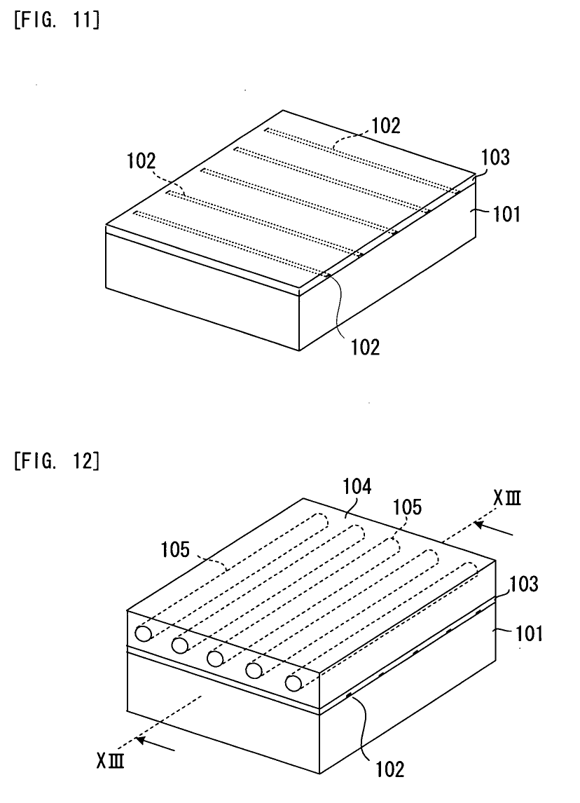

Next, with reference to FIG. 11 to FIG. 15, an explanation will be given to an embodiment of the method of preparing the bulkheads of the plasma display panel of the present invention. Each of FIG. 11 to FIG. 15 shows each process in the embodiment of the method of preparing the bulkheads of the plasma display of the present invention. For example, the bulkheads 19 of the plasma display panel 1 described above can be prepared by this preparing method.

Firstly, as shown in FIG. 11, electrodes 102 and a dielectric layer 103 are formed on a substrate 101. The formation of the electrodes 102 can use, for example, a photolithography technology. Incidentally, the substrate 101, the electrodes 102, and the dielectric layer 103 constitute the rear substrate 11, the electrodes 13, and the dielectric layer 14 of the plasma display panel 1 described above.

Then, as shown in FIG. 12, a bulkhead layer 104 made of a glass material or a resin material is formed on the dielectric layer 103.

In the process of forming the bulkhead layer 104, a plurality of magnetic materials 105 are embedded in the bulkhead layer 104. Each of the magnetic materials 105 is disposed in a bar shape, extending from one edge side to the other edge side of the bulkhead layer 104 in a direction parallel to a surface 101A of the substrate 101 and in a direction perpendicular to the extending direction of the electrodes 102.

Then, as shown in FIG. 13, a mask 106 for forming grooves or holes which shape a plurality of discharge unit spaces is formed on the bulkhead layer 104 to cut the magnetic materials 105 along a direction crossing the extending direction of the magnetic materials 105. Incidentally, FIG. 13 is a cross sectional showing a condition in which the mask 106 is formed on the bulkhead layer 104, viewed in an arrow XIII-XIII direction in FIG. 12.

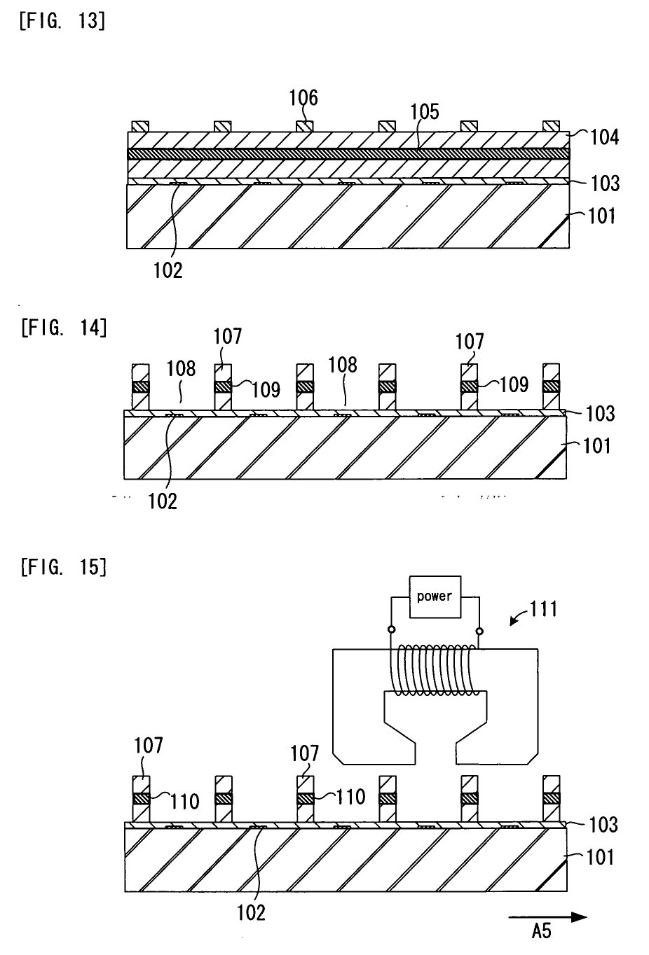

Then, as shown in FIG. 14, one portion of the bulkhead layer 104 and one portion of the magnetic materials 105 are removed on the basis of the mask 106. By this, a plurality of bulkheads 107, a plurality of long grooves 108, and a plurality of magnetic member pieces 109 are formed. Sandblasting can be used to remove one portion of the bulkhead layer 104 and one portion of the magnetic materials 105. Incidentally, the bulkheads 107 and the long grooves 108 make the bulkheads 19 and the discharge unit spaces C of the plasma display panel 1 described above.

Then, as shown in FIG. 15, a magnetic field is applied to the plurality of magnetic member pieces 109 in order to provide a magnetic force to the plurality of magnetic member pieces 109. Incidentally, magnetic members 110 make the magnetic members 22 of the plasma display panel 1 described above. Moreover, a magnetic field applying apparatus 111 can be used to provide a magnetic field to the magnetic member pieces 109. For example, a magnetic force can be provided to the magnetic member pieces 109 by displacing, in an arrow A5 direction, the substrate 101 with the bulkheads 107 and the magnetic member pieces 109 formed while a magnetic field is generated on the magnetic field applying apparatus 111.

In this manner, the bulkheads of the plasma display panel are completed.

Incidentally, in the above-mentioned preparation method, such a case is explained that a magnetic force is applied to the magnetic member pieces 109 after the formation of the bulkheads 107. The present invention, however, is not limited to this case. A magnetic force may be applied to the magnetic materials 105 before the magnetic materials 105 are embedded in the bulkhead layer 104. In this case, a magnetic force may be applied to the magnetic member pieces 109 in order to match the magnetic poles of the magnetic member pieces 109 after the formation of the bulkheads 107.

According to the method of preparing the bulkheads of the plasma display panel as described above, it is possible to easily prepare the bulkheads provided with the magnetic members. Moreover, it is possible to uniformly distribute the magnetic members in all the discharge unit spaces. By this, it is possible to form a uniform mirror magnetic field in each discharge unit space, to thereby provide uniform brightness in each discharge unit space. Therefore, it is possible to provide a highly bright, high-resolution plasma display panel.

Incidentally, in the present invention, various changes may be made without departing from the essence or spirit of the invention which can be read from the claims and the entire specification. A plasma display panel, and a method of preparing bulkheads thereof, which involve such changes, are also intended to be within the technical scope of the present invention.

### INDUSTRIAL APPLICABILITY

The plasma display panel, and the method of preparing bulkheads thereof according to the present invention can be applied to a plasma display panel preferably used for a display for television, a display for information notice, or the like, and to a method of preparing bulkheads thereof.

1. A plasma display panel comprising:
a first substrate;
a second substrate facing said first substrate through a space in which a plurality of discharge unit spaces are formed;
a first electrode which is provided for each of the plurality of discharge unit spaces and which is disposed on a surface of either said first substrate and said second substrate, the surface facing the space side;
a second electrode which is provided for each of the plurality of discharge unit spaces and which is disposed on a surface of either said first substrate and said second substrate, the surface facing the space side;
a plurality of bulkheads for defining the plurality of discharge unit spaces by separating the space, said bulkheads being disposed between said first substrate and said second substrate; and
a mirror magnetic field forming device for forming a mirror magnetic field in each of the discharge unit spaces, said mirror magnetic field forming device being disposed in each of the plurality of discharge unit spaces,
said mirror magnetic field forming device comprising:
a first magnetic member disposed on one of the bulkheads facing each other through the discharge unit spaces; and
a second magnetic member disposed on the other of the bulkheads facing each other through the discharge unit space and having a magnetic pole opposite to that of the first magnetic member, the first magnetic member and the second magnetic member forming a magnetic field in which lines of magnetic force extend from the one bulkhead to the other bulkhead to penetrate the discharge unit space,
the first magnetic member and the second magnetic member forming the mirror magnetic field in the discharge unit space.

2. The plasma display panel according to claim 1, wherein the first magnetic member and the second magnetic member face each other, with the discharge unit space disposed between them.

3. The plasma display panel according to claim 1, wherein a length of the first magnetic member is shorter than a length of the discharge unit space in a direction perpendicular to a surface of the first substrate facing the space side, and a length of the second magnetic member is shorter than a length of the discharge unit space in a direction perpendicular to the surface of the first substrate.

4. The plasma display panel according to claim 1, wherein a length of the first magnetic member is shorter than a length of the discharge unit space in a direction parallel to a surface of the first substrate facing the space side and in a direction parallel to a surface of the one bulkhead facing the discharge unit space, and a length of the second magnetic member is shorter than a length of the discharge unit space in a direction parallel to the surface of the first substrate and in a direction parallel to a surface of the other bulkhead facing the discharge unit space.

5. The plasma display panel according to claim 1, wherein a shape of the first magnetic member is relatively point-like compared to that of a surface of the one bulkhead facing the discharge unit space, and a shape of the second magnetic member is relatively point-like compared to that of a surface of the other bulkhead facing the discharge unit space.

6. The plasma display panel according to claim 1, wherein a distance between the first magnetic member and a first inner surface of the discharge unit space disposed on said first substrate side is substantially equal to a distance between the first magnetic member and a second inner surface of the discharge unit space disposed on said second substrate side, and a distance between the second magnetic member and the first inner surface is substantially equal to a distance between the second magnetic member and the second inner surface.

7. The plasma display panel according to claim 1, wherein the first magnetic member is disposed in a substantially central part of a surface of the one bulkhead facing the discharge unit space, and the second magnetic member is disposed in a substantially central part of a surface of the other bulkhead facing the discharge unit space.

8. The plasma display panel according to claim 1, wherein a surface of the first magnetic member facing the discharge unit space and a surface of the one bulkhead facing the discharge unit space are in a same plane, and a surface of the second magnetic member facing the discharge unit space and a surface of the other bulkhead facing the discharge unit space are in a same plane.

9. The plasma display panel according to claim 1, wherein the first magnetic member projects from a surface of the one bulkhead facing the discharge unit space, and the second magnetic member projects from a surface of the other bulkhead facing the discharge unit space.

10. A method of preparing bulkheads of a plasma display panel comprising: a first substrate; a second substrate facing said first substrate through a space in which a plurality of discharge unit spaces are formed; a first electrode which is provided for each of the plurality of discharge unit spaces and which is disposed on a surface of either said first substrate and said second substrate, the surface facing the space side; a second electrode which is provided for each of the plurality of discharge unit spaces and which is disposed on a surface of either said first substrate and said second substrate, the surface facing the space side; a plurality of bulkheads for defining the plurality of discharge unit spaces by separating the space, said bulkheads being disposed between said first substrate and said second substrate; and a mirror magnetic field forming device for forming a mirror magnetic field in each of the discharge unit spaces, said mirror magnetic field forming device being disposed in each of the plurality of discharge unit spaces, said mirror magnetic field forming device comprising: a first magnetic member disposed on one of the bulkheads facing each other through the discharge unit spaces; and a second magnetic member disposed on the other of the bulkheads facing each other through the discharge unit space and having a magnetic pole opposite to that of the first magnetic member, the first magnetic member and the second magnetic member forming a magnetic field in which lines of magnetic force extend from the one bulkhead to the other bulkhead to penetrate the discharge unit space, the first magnetic member and the second magnetic member forming the mirror magnetic field in the discharge unit space,
said method comprising processes of
forming a bulkhead layer on said first substrate;
disposing magnetic materials in a bar shape, extending from one edge side to the other edge side of the bulkhead layer in a direction parallel to the surface of said first substrate;
forming a mask for forming grooves or holes which shape the plurality of discharge unit spaces, on the bulkhead layer to cut the magnetic materials along a direction crossing an extending direction of the magnetic materials;
removing one portion of the bulkhead layer and one portion of the magnetic materials on the basis of the mask, to thereby form the plurality of bulkheads, the plurality of discharge unit spaces, a plurality of first magnetic member pieces which make the plurality of first magnetic members, and a plurality of second magnetic member pieces which make the plurality of second magnetic members; and
applying a magnetic field to the plurality of first magnetic member pieces and the plurality of second magnetic member pieces in order to provide a magnetic force to the plurality of first magnetic member pieces and the plurality of second magnetic member pieces or in order to match magnetic poles of the plurality of first magnetic member pieces and the plurality of second magnetic member pieces, to thereby form the plurality of first magnetic members and the plurality of second magnetic members.
